(19) United States
(12) Patent Application Publication
(10) Pub. No.: US 2007/0234029 A1
(43) Pub. Date: Oct. 4, 2007

(54) Methods and apparatus for context sensitive component dispatch management

(76) Inventors: Michael A. Rothman, Puyallup, WA (US); Mallik Bulusu, Olympia, WA (US); Robert C. Swanson, Olympia, WA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/391,041

(22) Filed: Mar. 28, 2006

(51) Int. Cl. G06F 9/00; G06F 15/177

(52) U.S. Cl. 713/2

(57) ABSTRACT

Methods and apparatus for context sensitive component dispatch management to boot a processor are disclosed. An example method includes creating a driver that has dependency components for booting a target by identifying data associated with a boot target and using the data to determine which of the dependency components are valid for the boot target. The example method further includes augmenting a dependency expression associated with the driver with additional information indicative of the validity of the dependency components of the driver for the boot target and storing the additional information with the dependency expression.

### FIELD OF THE DISCLOSURE

This disclosure relates generally to processor systems, and, more particularly, to methods and apparatus for context sensitive component dispatch management to reduce boot times in processor systems.

### BACKGROUND

In a conventional computer system, software code is executed from read only memory (ROM) or random access memory (RAM), and an operating system (OS) is stored either on a hard drive, compact discs, or universal serial bus (USB) flash drives. When a computer is first powered, it does not have an OS in the memory, thus the computer needs to load and execute instructions to initiate the OS; this is commonly referred to as booting the OS. In most booting processes, the processor executes software or firmware stored in the ROM to search for devices required for the booting process.

An example of such software/firmware is the known basic input/output system (BIOS), which is typically stored in a flash memory. BIOS, as software/firmware, can be viewed as a heterogeneous blend of software/firmware modules catering to a multitude of operating contexts or boot paths such as, for example, normal boot path mode, system management mode (SMM), recovery mode, post memory manager (PMM) mode, etc. The software modules are drivers that are each programmed to interact with a particular device or perform a particular function. Drivers have dependency expressions that are dispatched prior to initialization of the driver. Not all dependencies may be required to cause a driver to be operable, but usually all dependencies are dispatched.

Modularity of the software/firmware is a salient feature of the latest generations of BIOS. However, for better management of the flash memory, code is often written in a way that reduces its modularity. For example, the code may be shared across operating contexts or boot paths, for example with dual mode drivers. In addition, typical processors and/or platforms are unable to determine precisely what hardware must be initialized to load the OS or other boot target. Consequently, in traditional designs, the BIOS initializes the entire platform i.e., all the hardware that the BIOS locates. This directly increases boot time.

Pre-boot indicators, such as the time it takes to complete the boot process, are key metrics of server performance. Particularly in volume servers, longer booting times imply problems getting the hardware certified as “highly available” or as having five 9s (i.e., 99.999%). Longer boot times also signify that the hardware is less competitive in earning high performance computing (HPC) awards and also indicate an overall poor user experience in node based processing.

As OSs and platforms become even more complex by including many features having varying requirements, boot times are inevitably increased to well in excess of what is otherwise tolerable for certain HPC applications. The standard requirement is to boot well under a minute—even in enterprise class platforms. In fact, if a boot time of a platform does not fall within a certain metric, that platform cannot be certified as highly available because the time it takes to boot could exceed the margin of time available for a yearly reboot.

### BRIEF DESCRIPTION OF THE DRAWINGS

FIG. 1 is a block diagram illustrating a comparison of the boot times for a traditional system and a system with an example disclosed context sensitive component dispatch management functionality.

FIG. 2 is a block diagram illustrating an example disclosed processor boot system.

FIG. 3 is a block diagram illustrating an example boot process using context sensitive component dispatch.

FIG. 4 illustrates an example augmented dependency expression having an example bitmap matrix.

### DETAILED DESCRIPTION

The illustrated examples described herein disclose methods and apparatus for context sensitive component dispatch management to reduce boot time. An example method includes augmenting at least one dependency expression of a driver with additional information, wherein the additional information is derived from a boot target that requires the driver to operate. The example method further includes using the additional information to identify valid dependency requirements for the driver, and dispatching only valid dependency requirements for the driver to operate the boot target. Finally, the target is booted once the valid dependency requirements are dispatched.

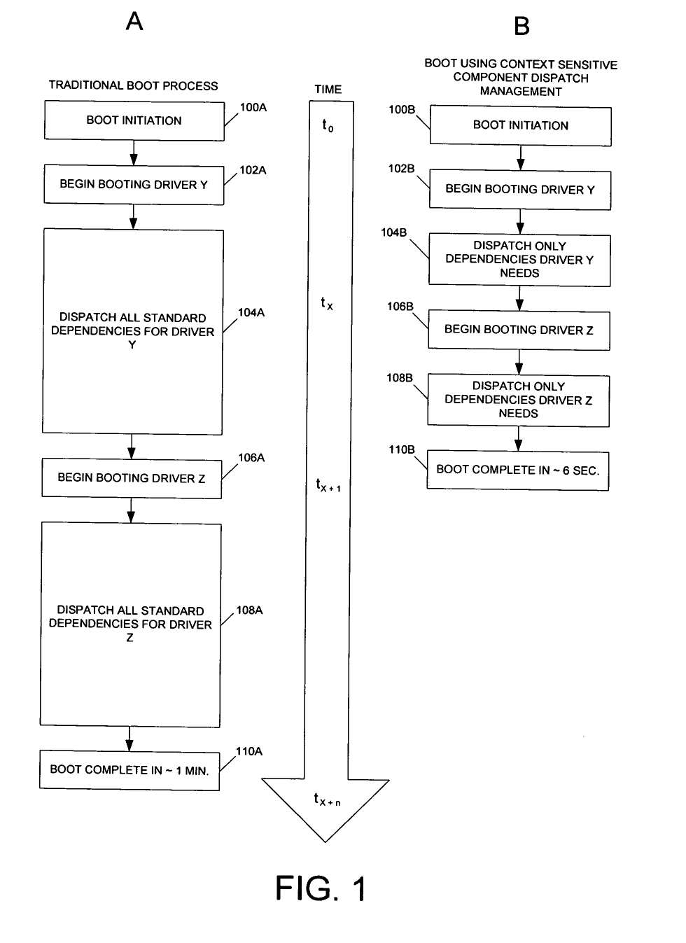

FIG. 1 is a block diagram that illustrates the relative speed of the booting process between the prior art Processor A (Column A) carrying out a conventional boot process and a Processor B practicing the disclosed context sensitive component dispatch management (Column B). As shown in FIG. 1, both Processors A and B begin boot initiation (blocks 100A and 100B). To begin booting, the Processors A and B boot a driver such as, for example, driver Y at t₀ (blocks 102A and 102B). To boot driver Y, Processor A dispatches all dependencies for driver Y (block 104A), i.e., Processor A initializes whatever hardware Processor A locates. Contrarily, Processor B practices context sensitive component dispatch management, which as described below in detail, only dispatches the dependencies that driver Y needs based on augmented dependency expressions (DEPEXs) contained in the firmware for driver Y (block 104B). As noted below, these dependencies may be, among other things, based on the boot target of processor. As shown in FIG. 1, dispatching all dependencies for driver Y (block 104A) takes much longer than dispatching only the dependencies that driver Y needs to operate (block 104B). Next, Processor B moves onto boot driver Z (block 106B) by loading only the dependencies driver Z needs to operate (block 108B). Then Processor B completes booting (block 110B).

As shown in FIG. 1, because Processor B has the ability to stipulate dynamic dependencies that are driven, for example, by the boot target data (i.e., selectively dispatch components based on the content of the DEPEXs), Processor B takes a relatively shorter time than Processor A to complete the boot process. For example, Processor B may take as little as approximately six seconds to boot. Meanwhile, Processor A is still booting because Processor A takes well over six seconds to do so. As shown in FIG. 1, even after Processor B has completed booting, Processor A begins to boot driver Z (block 106A) by loading everything related to driver Z (block 108A). This takes a considerable amount of time relative to the execution carried out by Processor B. In fact Processor A does not complete booting (block 110A), until much later than Processor B, as much as over ten times longer. For example, Processor A may take over one minute to boot.

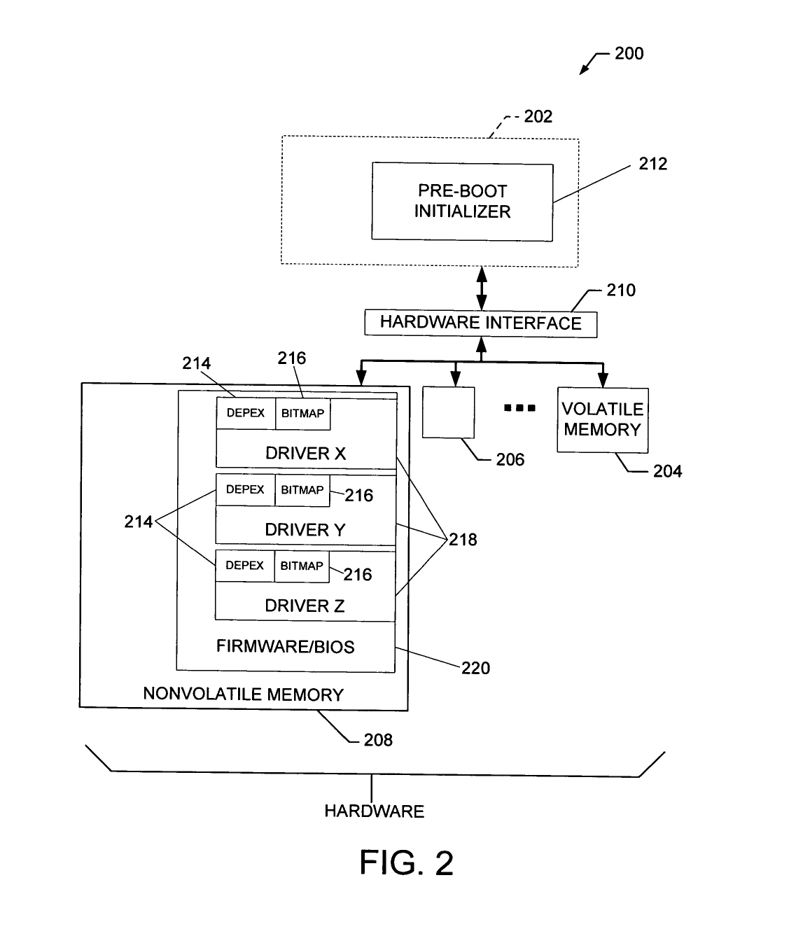

FIG. 2 is a schematic diagram illustrating an example disclosed processor boot system 200 (e.g., Processor B from FIG. 1). In the example of FIG. 2, a processor 202 interacts with a plurality of hardware devices 204, 206, 208 via a hardware interface 210. The hardware devices 204, 206, 208 may include, for example, volatile memory 204, video graphic adapters, network interfaces, input/output devices, etc. 206, and flash and other non-volatile memory 208. The processor 202, hardware interface 210, and the hardware devices 204, 206, 208 may be integrated into a single computer or server platform. The processor 202 may be a general purpose microprocessor, or a dedicated device that is able, among other things, to realize pre-boot initialization actions.

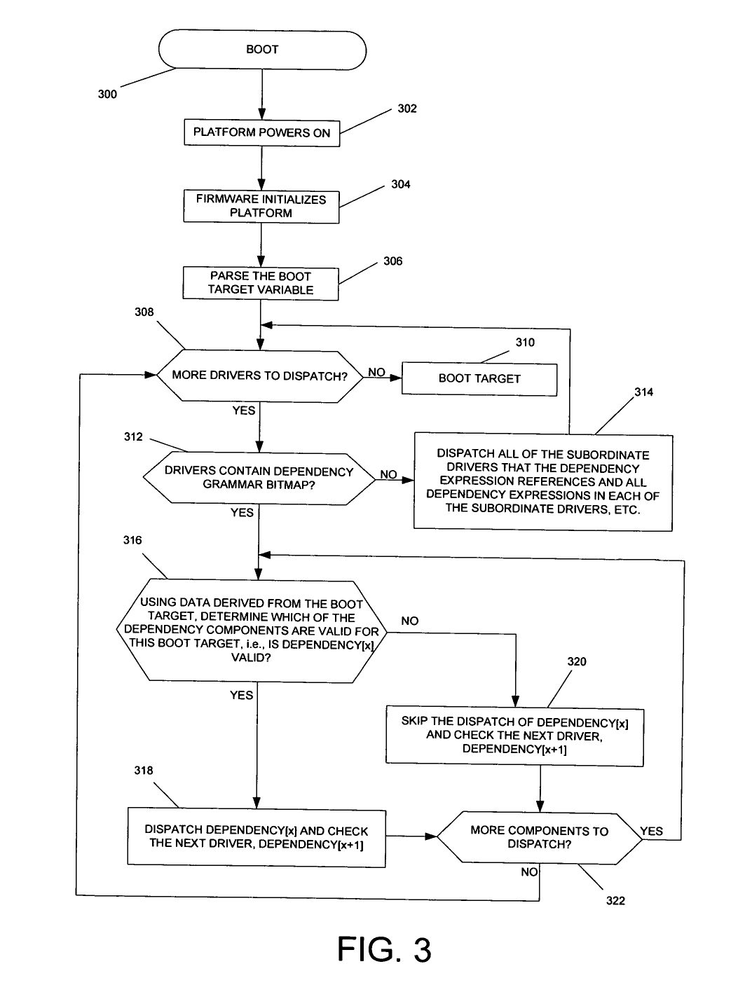

Some example pre-boot initialization actions include the discovery, identification, sorting, address assignment, configuration space programming, running of option ROMs, firmware/BIOS configuration, etc. of each computer or server platform device. Thus, the processor 202 includes a pre-boot initializer 212 to implement, among other things discussed below, these pre-boot initialization actions. In particular, with respect to the illustrated example, the pre-boot initializer 212 implements the context sensitive component dispatch management process, which is described below in conjunction with FIG. 3.

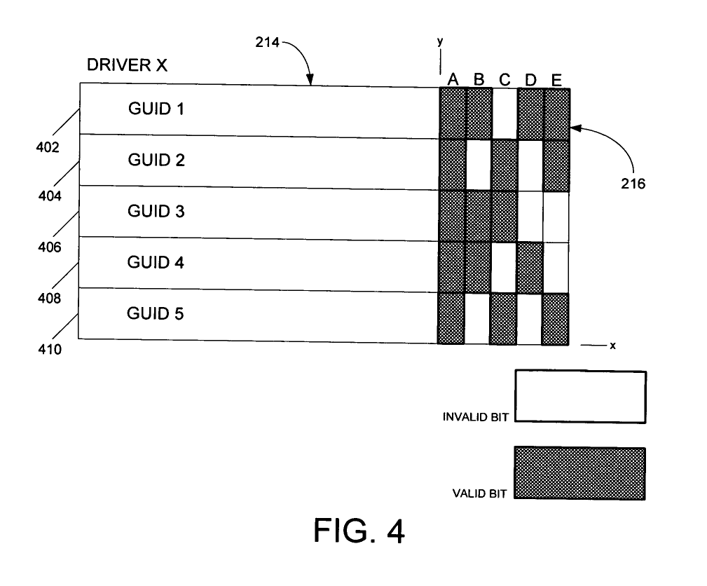

In one example, the pre-boot initializer 212 accesses the flash or nonvolatile memory 208 to access the control code such as the firmware/BIOS 220 contained there. The firmware/BIOS 220 contains the instructions needed to initialize the computer or server and to instantiate the context sensitive component dispatch functionality. The firmware/BIOS 220 includes a plurality of drivers 218 that interact with particular devices in the system. Each driver 218 includes associated DEPEXs 214. Attached to the DEPEXs is additional information 216 that may be in the form of a vector or a matrix, such as bitmap matrix. The additional information 216 may also be referred to as a dependency grammar bitmap, but the term “matrix” or “matrices” is used most often herein, and this term is not meant to limit the manner in which the DEPEXs 214 may be augmented with additional information. The matrices 216, the details of which are shown in an example matrix 216 in FIG. 4, include data indicating what drivers 218 and/or components of the drivers should be dispatched or are valid, i.e., what drivers 218 are needed to load and operate the OS or other boot target.

The additional information in the matrices 216 is added to the DEPEXs 214 during the build phase of the processor. The DEPEXs 214 and matrices 216 are stored in the flash or other non-volatile memory 208 to ensure their availability during each booting process. However, any portion of the flash memory 208 may be copied and executed or loaded to the volatile memory 204 during initialization. The structure and content of the DEPEXs 214 and the matrices 216 are discussed in greater detail below.

FIG. 3 illustrates an example boot process 300 practicing context sensitive component dispatch management. The process 300 begins when a computer is first powered or restarted. This powers up the platform (block 302) and the firmware beings to initialize the platform (block 304). Next, the OS or boot target is identified and the boot target variables are parsed (block 306). At this point the pre-boot initializer 212 reads the DEPEXs 214 in the flash memory 208. The DEPEXs 214 are augmented with additional information 216 that is used to determine what drivers 218 or components (e.g., drivers, services or complete applications) should be loaded to load or operate the OS or other boot target. Consequently, the DEPEXs 214 have been constructed with an optimal set of boot content based on the boot target. The additional information 216 may be in the form of the matrices 216, as shown in FIG. 2.

The pre-boot initializer 212 accesses the flash memory 208 to determine what components or drivers 218 should be dispatched to load and operate the target and if there are more components or drivers 218 left to dispatch for this purpose (block 308). Once all necessary components or drivers have been dispatched, the processor 202 boots the target (block 310).

If there are more components and/or another driver 218 to dispatch, the initializer 212 identifies whether or not the drivers 218 left to be dispatched contain additional information 216 in their associated DEPEXs 214 (block 312). If the driver 218 in question does not have a matrix 216 attached to its DEPEXs 214, then the pre-boot initializer 212 will initialize all subordinate drivers 218 that the DEPEX 214 references and will further initialize each dependency expression in each subordinate driver 218 and so forth (block 314).

If the DEPEXs 214 associated with the drivers 218 left to be dispatched contains a matrix 216, the initializer 212, reads the matrix 216 and determines which dependency components in the driver 218 are valid for booting the target in question (block 316). Valid dependency components are components that are needed to load and/or operate the boot target. The structure of an example bitmap 216 is discussed in more detail below (FIG. 4).

If the dependency for the component is valid, the component is dispatched, and the next component for the driver 218 in question is checked (block 318). If the component is not valid, the component is skipped without being dispatched and the next component is checked (block 320). The processor 202 is sensitive to the context of the DEPEXs 214 and matrices 216 with respect to component dispatch management. After properly processing a valid component (block 318) or an invalid component (block 320), the initializer will determine if there are any more components to dispatch for the driver 218 in question (block 322). If there are more components to check and/or dispatch for the driver 218 in question, then the process continues by determining which dependency components in the matrix 216 are valid for booting the target in question (block 316) and so forth through blocks 318, 320 and 322 until it is determined that no more components for the driver 218 in question need to be dispatched (block 322). At this point the process 300 returns to determining if any more drivers 218 are to be dispatched (block 308) and analyzing and dispatching the remaining drivers 218 and their components (blocks 308, 312, 314, 316, 318, 320 and 322) or completing the process 300 and booting the target (block 310).

FIG. 4 illustrates an example DEPEX 214 that is augmented with additional information in the form of a bitmap matrix 216. In a traditional system, the matrix 216 would not be attached to the DEPEX 214. Thus, in the conventional systems, when the driver was being loaded during boot, all of the components 402, represented by global unique identifiers (GUID) number 1-5 listed in the DEPEX 214 would be loaded. The components 402 could also be application programming interfaces (API) or other components needed to load and operate an OS or other boot target. In the example augmented DEPEX 214, the matrix 216 indicates which components 402 are necessary to load and operate any particular driver 218 or boot target.

In the illustrated example of FIG. 4, the x-axis of the matrix 216 represents a boot target and the y-axis represents the components 402 of the DEPEX 214, both valid and invalid. Valid components, which are the components 402, 404, 406, 408, 410 needed to load and operate the corresponding boot target, are flagged in the matrix 216 (in FIG. 4, the valid components are shaded). An identifier (not shown) identified which components 402, 404, 406, 408, 410 are valid, and indicates to a dispatcher (not shown) to dispatch the valid components 402, 404, 406, 408, 410. Thus, for example, to load and operate the first boot target A, which may be an operating system, all five components 402, 404, 406, 408, 410, i.e., GUIDs 1-5, must be dispatched. To load and operate the second boot target B, which may be another platform, only components 402, 406, and 408, i.e. GUIDs 1, 3, and 4, need to be loaded. In a traditional system, GUIDs 1-5 would be dispatched, but in the present example only GUIDs 1, 3, and 4 are dispatched to load and operate the second boot target B; therefore, the second boot target B would be booted in the illustrated example faster than in traditional systems. The third, fourth and fifth boot targets C, D, and E would also boot faster in the illustrated example that in traditional systems. As shown in FIG. 4, for the third boot target C to load and be operable, components 404, 406 and 410, i.e. GUIDs 2, 3 and 5, must be dispatched. The fourth boot target D only requires components 402 and 408, i.e. GUIDs 1 and 4, and the fifth boot target E requires components 402, 404, and 410, i.e. GUIDs 1, 2 and 5.

The matrix 216 is seeded into the flash memory 208 during the build phase. With the addition of the matrix 216, the drivers 218 broadcast what GUIDs they consume or produce, which indicates to the pre-boot initializer 212 what components 402 must be dispatched for the driver 218 to be loaded and operated. Making the processor 202 more intelligent helps the processor 202 load only those components 402 that need to be loaded and not all the unnecessary components. Because the processor 202 optimizes the set of boot content based on the boot target, the processor 202 boots the system faster.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method of creating a driver that has dependency components for booting a target, the method comprising:
identifying data associated with a boot target;
using the data to determine which of the dependency components are valid for the boot target;
augmenting a dependency expression associated with the driver with additional information indicative of the validity of the dependency components of the driver for the boot target; and
storing the additional information with the dependency expression.

2. A method as defined in claim 1, wherein the additional information comprises a vector when the dependency expression is augmented with the additional information.

3. A method as defined in claim 1, wherein there are multiple dependency expressions for the driver.

4. A method as defined in claim 2, wherein additional information comprises a matrix when the multiple dependency expressions are augmented with the additional information.

5. A method as defined in claim 1, further comprising repeating the method for at least a second driver.

6. An article of manufacture storing machine readable instructions comprising a dependency expression associated with a driver, the dependency expression comprising at least one dependency component and additional information, wherein the additional information is related to a boot target.

7. An article of manufacture as defined in claim 6, wherein the additional information indicates whether the at least one dependency component is needed to at least one of load or operate a boot target.

8. An article of manufacture as defined in claim 6, wherein the additional information comprises at least one of a vector or a matrix.

9. An article of manufacture as defined in claim 6, wherein the additional information is used to reduce the time needed to boot the boot target.

10. A method of booting a processor, the method comprising:
determining if a driver that as at least one dependency expression for at least one dependency component needs to be dispatched;
determining if the at least one dependency expression contains additional information indicating which of the at least one dependency component is valid, wherein a valid dependency component is required by a boot target to at least one of load or operate;
dispatching the at least one dependency component for the driver only if the at least one dependency component was determined to be valid;
dispatching the driver; and
booting the target.

11. A method as defined in claim 10, wherein the additional information comprises at least a vector or matrix.

12. A method as defined in claim 10, wherein the method occurs faster than without the additional information.

13. An article of manufacture storing machine readable instruction which when executed cause a machine to selectively dispatch a driver by:
reading at least one dependency expression having context associated with at least one dependency component for a driver;
determining if the context of the at least one dependency expression indicates that the at least one component should be dispatched; and
dispatching the at least one component if the context of the at least one dependency expression indicates that the at least one component should be dispatched.

14. An article of manufacture as defined in claim 13, wherein the context of the at least one dependency expression contains additional information.

15. An article of manufacture as defined in claim 14, further determining if the additional information indicates if the at least one dependency component is necessary for at least one of loading or operating a boot target.

16. An article of manufacture as defined in claim 14, wherein the additional information comprises at least one of a vector or matrix.
